(19) United States
(12) Patent Application Publication
(10) Pub. No.: US 2007/0053191 A1
(43) Pub. Date: Mar. 8, 2007

(54) Light source module and projection apparatus using the same

(75) Inventors: Fu-Ming Chuang, Hsinchu (TW); Cheng Wang, Hsinchu (TW); Ting-Heng Hsieh, Hsinchu (TW)

Correspondence Address: BACON & THOMAS, PLLC, 625 SLATERS LANE, FOURTH FLOOR, ALEXANDRIA, VA, 22314, US

(73) Assignee: Young Optics Inc., Hsinchu (TW)

(21) Appl. No.: 11/512,105

(22) Filed: Aug. 30, 2006

(30) Foreign Application Priority Data
Sep. 7, 2005 (TW) 94130737

(51) Int. Cl. F21V 7/00

(52) U.S. Cl. 362/299

(57) ABSTRACT

A light source module includes a light source, a paraboloid reflector and an aspheric lens. The light source is used for generating a first light. The paraboloid reflector is used for reflecting the first light beam to form a second light. The aspheric lens is used for converging the second light. The aspheric lens includes an aspheric incident surface and an emergent surface. The aspheric incident surface is used for converging the second light beam into a third light, and the emergent surface is used for converging the third light. The emergent surface includes two aspheric curved surfaces configured symmetric to an optical axis of the aspheric lens.

This application claims the benefit of Taiwan application Serial No. 94130737, filed Sep. 7, 2005, the subject matter of which is incorporated herein by reference.

### BACKGROUND OF THE INVENTION

1. Field of the Invention

The invention relates to a light source module and a projection apparatus using the same, and more particularly to a light source module using a paraboloid reflector in configuration with an aspheric lens, and a projection apparatus using the same.

2. Description of the Related Art

FIG. 1A is a schematic diagram of a conventional projection apparatus. Referring to FIG. 1A, a conventional projection apparatus 100 includes a light source module 110 and an integration rod 120. The light source module 110 includes a light source 112 and an ellipsoid reflector 114. The light source 112, such as an arc lamp, is used for generating a first light beam L1, and a center O of the light source 112 is disposed on a first focal point F1 of the ellipsoid reflector 114. The ellipsoid reflector 114 is for reflecting the first light beam L1 to form a second light beam L2, and the second light beam L2 converges into a collecting point Q on an incident terminal I of the integration rod 120 and a central axis Z.

However, as shown in FIG. 1B, an arc gap Dg of the light source 112 increases as time passes, such as gradually increases from 1.0 mm to 1.3 mm, or even continuously increases to 1.8 mm. When the arc gap increases from Dg to Dg′, a position of the center O of the light source 112 deviates from the first focal point f1 to a point O′ and thus a position of the collecting point Q formed by the second light beam L2 deviates from the incident terminal I to a point Q′, which in turn reduces the integration efficiency of the light source module 110. That is, the illumination efficiency of the light source 112 is very sensitive to the arc gap Dg and reduces along with the increase of the arc gap Dg. Especially, the smaller the panel used by the projection apparatus 100 is, the lower integration efficiency of the light source module 110 becomes, and the shorter is the lifetime of the projection apparatus 100.

### SUMMARY OF THE INVENTION

An object of the invention is providing a light source module and projection apparatus using the same. The light source module provides parallel reflected light beam by a paraboloid reflector and converges the reflected light beam by an aspheric lens with a specific lens to reduce the sensitivity of the illumination efficiency of the light source to the variation of the arc gap of the light source and thus elongate lifetime of the projection apparatus.

The invention achieves the above-identified object by providing a light source module including a light source, a paraboloid reflector and an aspheric lens. The light source is used for generating a first light beam. The paraboloid reflector is used for reflecting the first light beam to form a second light beam. The aspheric lens is used for converging the second light beam. The aspheric lens includes an aspheric incident surface and an emergent surface. The aspheric incident surface is used for converging the second light beam into a third light, and the emergent surface is used for converging the third light. The emergent surface includes two aspheric curved surfaces configured symmetric to an optical axis of the aspheric lens.

The invention achieves the above-identified object by providing a projection apparatus including a light source module and an integration rod. The light source module includes a light source, a paraboloid reflector and an aspheric lens. The light source is used for generating a first light beam. The paraboloid reflector is used for reflecting the first light beam to form a second light. The aspheric lens is for converging the second light. The aspheric lens includes an aspheric incident surface and an emergent surface. The aspheric incident surface is used for converging the second light beam into a third light, and the emergent surface is used for converging the third light beam into a fourth light. The emergent surface includes two aspheric curved surfaces configured symmetric to an optical axis of the aspheric lens. The integration rod is used for uniformizing the fourth light.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is a schematic diagram of a conventional projection apparatus.

FIG. 1B is a schematic diagram showing that the integration efficiency of a conventional light source in FIG. 1A is reduced as an arc gap increases.

FIG. 2 is a schematic diagram of a projection apparatus according to a preferred embodiment of the present invention.

FIG. 3 is a function relationship of the illumination efficiency and the arc gap of the light sources in light source modules using the same paraboloid reflector (F=10) respectively configured with an aspheric lens, a common aspheric lens, and a conventional ellipsoid reflector according to the present invention.

FIG. 4 is a function relationship of the illumination efficiency and the arc gap of the light sources in light source modules using a paraboloid reflector with the focal length 10, 7 and 6 mm respectively configured with an aspheric lens and a conventional ellipsoid reflector according to the present invention.

FIG. 5 is a function relationship of the illumination efficiency of a light source and the size of a panel respectively in projecting systems F#=2.4 and 2.8 of the light source module according to the present invention and in a projecting system F#=2.4 of the conventional ellipsoid reflector.

FIG. 6 is another cross-sectional diagram of the aspheric lens of the light source module in FIG. 2.

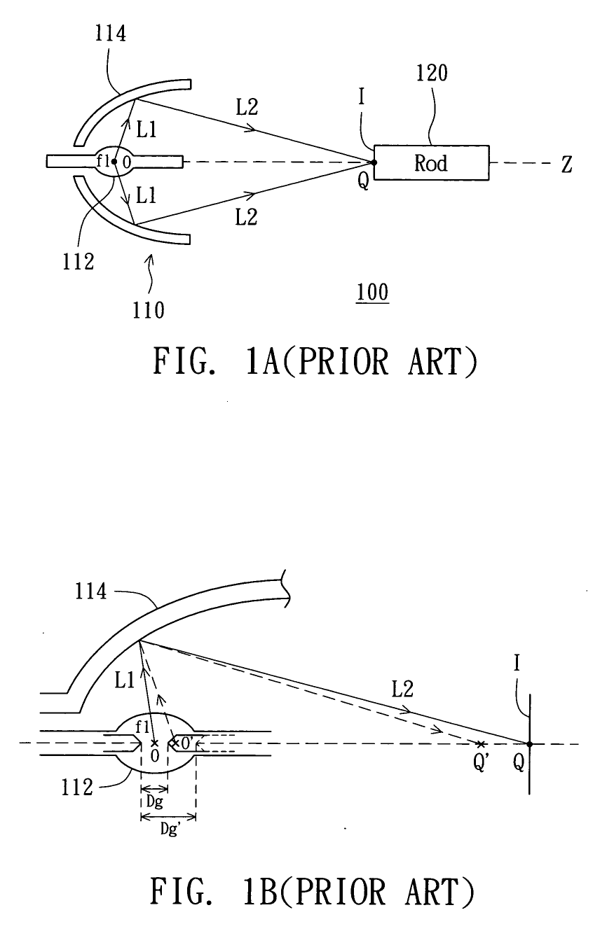

### DETAILED DESCRIPTION OF THE INVENTION

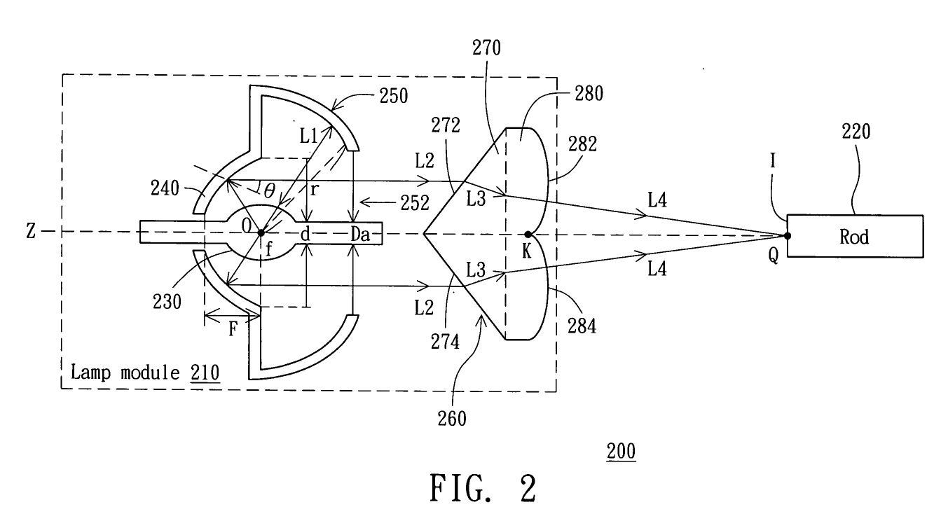

Referring to FIG. 2, a schematic diagram of a projection apparatus according to a preferred embodiment of the present invention is shown. The projection apparatus 200 includes a light source module 210 and an integration rod 220. The light source module 210 includes a light source 230, a paraboloid reflector 240, a minor reflector 250 and an aspheric lens 260. The light source 230, such as an arc lamp, is used for generating a first light beam L1, and a center O of the light source 230 is disposed on the focal point f of the paraboloid reflector 240. The paraboloid reflector 240 is used for reflecting the first light beam L1 to form a second light beam L2 in parallel to an optical axis Z. A focal length F of the paraboloid reflector 240 is 10 mm for instance.

The minor reflector 250 is connected to the paraboloid reflector 240. The minor reflector 250, such as a spherical reflector, has an emergent opening 252. A central axis of the emergent opening 252 coincides with the central axis Z. The diameter Da of the opening 252 is larger than the caliber d of the paraboloid reflector 240 so that the second light beam L2 reflected by the paraboloid reflector 240 is incident into the aspheric lens 260 through the opening 252. A curvature center of the minor reflector 250 coincides with the center O of the light source 230. The minor reflector 250 is used for reflecting a part of the first light beam L1 toward the paraboloid reflector 240 to form the second light beam L2 in order to improve an illumination efficiency of the light source 230. The curvature radius r of the minor reflector 252 is larger than a half (d/2) of the caliber d of the paraboloid reflector 240. Besides, the minor reflector 250 includes an ellipsoid reflector. The first light beam L1 reflected by the paraboloid reflector 240 has a reflecting angle θ. A maximum value max(θ) of the reflecting angle is not smaller than 45 degrees so that all of the first light beam L1 reflected by the minor reflector 250 return to the paraboloid reflector 240 to form the second light beam L2 in parallel to the optical axis Z. For example, in the embodiment, the maximum angle max(θ) is 45 degrees.

The aspheric lens 260 is used for converging the second light beam L2. The aspheric lens 260 includes an incident surface 270 and an emergent surface 280. The incident surface 270 is used for converging the second light beam L2 into a third light beam L3 and the emergent surface 280 used is for converging the third light beam L3 into a fourth light beam L4 to form an collecting point Q on an incident terminal I of the integration rod 220. The integration rod 220 is used for uniformizing the fourth light beam L4. As shown in FIG. 2, the incident surface 270 includes two approximately wedge-shaped curved surfaces 272 and 274 configured symmetric to the optical axis Z. For example, each of the curved surfaces 272 and 274 has a curvature radius R=3.081753, and the conic constant Conic=−2.73106. The emergent surface 280 includes two aspheric curved surfaces 282 and 284 configured symmetric to the optical axis Z, and the aspheric surfaces 282 and 284 form an inflection point K on the optical axis Z. For example, each of the aspheric curved surfaces 282 and 284 has a curvature radius R=−19.193375, a conic constant Conic=−1.340937, and a first aspheric constant β₁=0.706046.

By using the above-mentioned aspheric lens 260 in configuration with the paraboloid reflector 240, The fourth light beam L4 is converged more effectively to improve the illumination efficiency of the light source module 210, and thus the sensitivity of the light source module 210 to variation of an arc gap Dg is reduced. In the following description, experiment data are provided to illustrate that the sensitivity of the light source module 210 to the arc gap Dg of the present invention is exactly reduced.

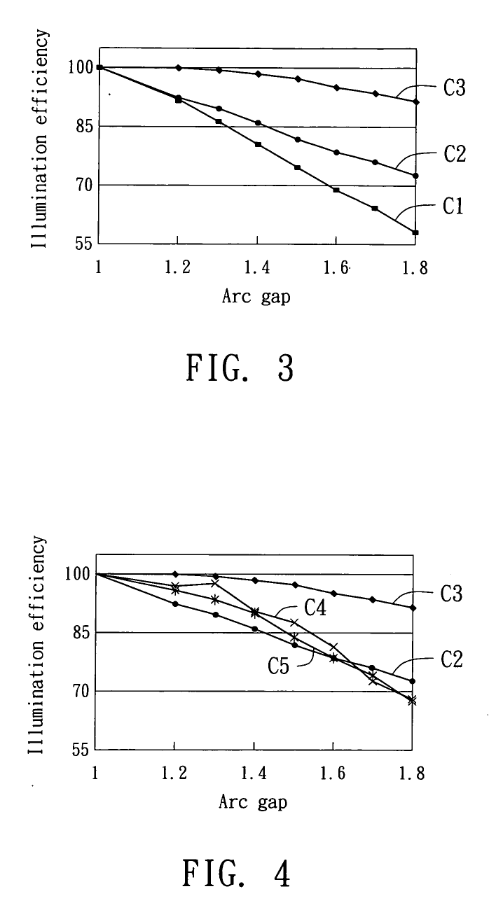

Referring to FIG. 3, a function relationship of the illumination efficiency and arc gap of the light sources in light source modules using a paraboloid reflector respectively configured with the aspheric lens 260 of the present invention, a common aspheric lens, and a conventional ellipsoid reflector is shown. The curve C1 represents a function relationship between the illumination efficiency and arc gap in a light source module using the common aspheric lens, the curve C2 represents a function relationship between the illumination efficiency and arc gap in a light source module using the conventional ellipsoid reflector, and the curve C3 represents a function relationship between the illumination efficiency and arc gap in a light source module using the aspheric lens 260 of the present invention. From the curves C1 and C3, it is noted that although the illumination efficiency of the light source can be improved as the common aspheric lens is used in the light source module, when the arc gap Dg increases from 1.0 mm to 1.8 mm, the illumination efficiency of the light source decreases from 100% to under 60%. Moreover, the light source module using the conventional ellipsoid reflector has an illumination efficiency of light source reduced from 100% to about 75%. However, when the arc gap Dg increases from 1.0 mm to 1.8 mm, the light source module 210 using the aspheric lens 260 of the present invention has an illumination efficiency of light source reduced by less 10% to maintain above 90%. Therefore, the light source module 210 of the present invention reduces the sensitivity of the illumination efficiency of the light source to the variation of the arc gap by using the aspheric lens 260.

Referring to FIG. 4, a function relationship of the illumination efficiency and arc gap of the light sources in light source modules using a paraboloid reflector with the focal length 10, 7 and 6 mm respectively configured with the aspheric lens 260 of the present invention and a conventional ellipsoid reflector is shown. Referring to FIG. 4, it is noted that the sensitivity of the illumination efficiency to the arc gap of a light source in the light source module using the paraboloid reflector, as shown the curve C3 with a focal length F=10 is lower than the sensitivity of the illumination efficiency to the arc gap of a light source in the light source module using the conventional ellipsoid reflector, as shown the curve C2. Besides, the sensitivity of illumination efficiency to arc gap (<1.6 mm) of a light source in the light source module using the paraboloid reflector with different focal length F (=6 or 7) as shown by the curves C4 and C5, is larger than the sensitivity of illumination efficiency to arc gap of a light source in the curve C2 of the light source module using the conventional ellipsoid reflector. Therefore, the aspheric lens 260 used in the light source module of the present invention has a good integration ability, which is configured with the paraboloid reflector 240 of various focal length F to effectively reduce the sensitivity of the illumination efficiency to arc gap of the light source.

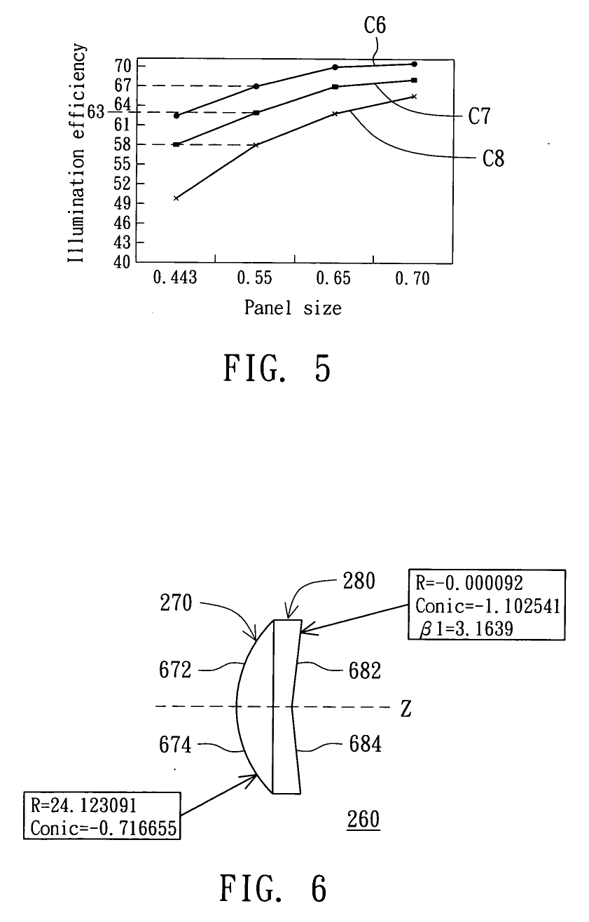

Referring to FIG. 5, a function relationship of the illumination efficiency between a light source and the size of a panel respectively in projection systems F#=2.4 and 2.8 of the light source module 210 of the invention and in a projection system F#=2.4 of the conventional ellipsoid reflector is shown. As shown in FIG. 5, in terms of a panel of the same size, such as 0.55 cm, the light source modules 210 of the invention in the systems F#=2.4 and 2.8 respectively have the illumination efficiency 67% and 63% as shown by the curves C6 and C7, which are larger than the illumination efficiency 58% (as shown by the curve C8) of the light source module of the conventional ellipsoid reflector in the system F#=2.4. That is, by using the light source module 210 of the present invention, the projection system F#=2.4 is replaced by the projection system F#=2.8 to save the cost. Although the illumination efficiency (63%) of the light source in the system F#=2.8 is slightly lower than the illumination efficiency of the light source of the system F#=2.4, it is still higher than the illumination efficiency of the light source of the conventional system F#=2.4 of the ellipsoid reflector. The projection system with a larger F# value has a smaller diameter of optical devices, such as a projecting lens, and thus yields a lower cost. Therefore, the projection apparatus reduces the system cost by using the light source module 210 of the present invention.

As described above, although the incident surface 270 is exemplified to include two approximately wedge-shaped curved surfaces 272 and 274 symmetric to the optical axis Z, and the emergent surface 280 is exemplified to include two aspheric curved surfaces 282 and 284 symmetric to the optical axis Z and having the inflection point K in the present invention. As shown in FIG. 6, in the light source module 210 of the present invention, the incident surface 270 of the, aspheric lens 260 also includes two aspheric curved surfaces 672 and 674 symmetric to the optical axis Z with the curvature radius R=24.123091 and the conic constant conic=−0.716655, and the emergent surface 260 also includes two approximately wedge-shaped curved surfaces 682 and 684 symmetric to the optical axis Z with the curvature radius R=−0.000042, the conic constant Conic=−1.102541, and the first aspheric constant β₁=3.1639. It is within the scope of the present invention, that the aspheric lens 260 has an aspheric incident surface for converging the second light beam L2 to form the third light beam L3 and the emergent surface includes two aspheric curved surfaces symmetric to the optical axis for converging the third light beam L3 to form the fourth light beam L4 and the collecting point Q on the integration rod so as to effectively increase the integration efficiency of the light source module 210 to achieve the purpose of reducing the sensitivity of the illumination efficiency of the light source to variation of the arc gap.

The light source module and projection apparatus using the same disclosed by the above-mentioned embodiment of the present invention has the following advantages:

1. The light source module of the present invention can reduce the sensitivity of the illumination efficiency of the light source to variation of the arc gap and thus largely increase the lifetime of the projection apparatus by using the design of the paraboloid reflector in configuration with the aspheric lens.

2. The light source module can largely increase the illumination efficiency of the light source by using the design of a paraboloid reflector and an aspheric lens.

3. Owing that the incident angle of the light beam reflected by the reflector for entering the integration rod can be adjusted by the aspheric lens in the projection apparatus, the required incident angle of the light beam for entering the integration rod of the projection system can be achieved by simply changing the aspheric lens, thereby saving the cost for changing the reflector.

4. As mentioned above, owing that the light source of the light source module in the present invention can provide a more converged light, the projection system with a small F# value can be replaced by the projection system having a large F# value to save the system cost.

5. Owing that the light beam reflected by a paraboloid reflector is approximately parallel in the light source module of the present invention, therefore the thermal flux issue of the light source module can be easier for processing.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light source module, comprising:
a light source, for generating a first light beam;
a paraboloid reflector, for reflecting the first light beam to form a second light beam; and
an aspheric lens, for converging the second light beam, the aspheric lens comprising:
an aspheric incident surface, for converging the second light beam into a third light beam; and
an emergent surface, for converging the third light, wherein the emergent surface comprises two aspheric curved surfaces configured symmetric to an optical axis of the aspheric lens.

2. The light source module according to claim 1, wherein the light source is disposed on a focal point of the paraboloid reflector, and the first light beam is reflected by the paraboloid reflector to form the parallel second light beam.

3. The light source module according to claim 2, further comprising a minor reflector connected to the paraboloid reflector, wherein the minor reflector comprises an emergent opening, a central axis of the emergent opening coincides with a central axis of the paraboloid reflector, and the minor reflector reflects a part of the first light beam toward the paraboloid reflector.

4. The light source module according to claim 3, wherein the minor reflector comprises a spherical reflector, and a curvature center of the spherical reflector coincides with a center of the light source.

5. The light source module according to claim 4, wherein a curvature radius of the spherical reflector is larger than a half of a caliber of the paraboloid reflector.

6. The light source module according to claim 3, the minor reflector comprises an ellipsoid reflector.

7. The light source module according to claim 3, wherein the first light beam is reflected by the paraboloid reflector to form the second light beam with a maximum reflecting angle, the maximum reflecting angle is not smaller than 45 degrees.

8. The light source module according to claim 3, wherein a diameter of the emergent opening is larger than the caliber of the paraboloid reflector.

9. The light source module according to claim 1, wherein the aspheric incident surface comprises two approximately wedge-shaped curved surfaces configured symmetric to the optical axis of the aspheric lens, and the aspheric curved surfaces form an inflection point on the optical axis of the aspheric lens.

10. The light source module according to claim 1, wherein each of the aspheric curved surfaces is an approximately wedge-shaped curved surface.

11. The light source module according to claim 1, is applied to a projection apparatus.

12. A projection apparatus, comprising:
a light source module, comprising:
a light source, for generating a first light beam;
a paraboloid reflector, for reflecting the first light beam to form a second light beam; and
an aspheric lens, for converging the second light, the aspheric lens comprising:
an aspheric incident surface, for converging the second light beam into a third light beam; and
an emergent surface, for converging the third light beam into a fourth light beam, wherein the emergent surface comprises two aspheric curved surfaces configured symmetric to an optical axis of the aspheric lens; and
an integration rod, for uniformizing the fourth light beam.

13. The projection apparatus according to claim 12, wherein the light source is disposed on a focal point of the paraboloid reflector, and the first light beam is reflected by the paraboloid reflector to form the parallel second light beam.

14. The projection apparatus according to claim 13, wherein the light source module further comprises a minor reflector connected to the paraboloid reflector, the minor reflector comprises an emergent opening, a central axis of the emergent opening coincides with a central axis of the paraboloid reflector, and the minor reflector reflects a part of the first light beam toward the paraboloid reflector.

15. The projection apparatus according to claim 14, wherein the minor reflector comprises a spherical reflector and a curvature center of the spherical reflector coincides with a center of the light source.

16. The projection apparatus according to claim 15, wherein a curvature radius of the spherical reflector is larger than a half of the caliber of the paraboloid reflector.

17. The projection apparatus according to claim 14, wherein the minor reflector comprises an ellipsoid reflector.

18. The projection apparatus according to claim 14, wherein the first light beam is reflected by the paraboloid reflector to form the second light beam with a maximum reflecting angle, the maximum reflecting angle is not smaller than 45 degrees.

19. The projection apparatus according to claim 14, wherein a diameter of the emergent opening is larger than a caliber of the paraboloid reflector.

20. The projection apparatus according to claim 13, wherein a focal length of the paraboloid reflector is not smaller than 6 mm.

21. The projection apparatus according to claim 12, wherein the aspheric incident surface comprises two approximately wedge-shaped curved surfaces configured symmetric to an optical axis of the aspheric lens, and the aspheric curved surfaces form an inflection point on the optical axis of the aspheric lens.

22. The projection apparatus according to claim 12, wherein each of the aspheric curved surfaces is an approximately wedge-shaped curved surface.
